(19) United States
(12) Patent Application Publication
(10) Pub. No.: US 2023/0304524 A1
(43) Pub. Date: Sep. 28, 2023

(54) Self Engaging And Disengaging Coupler

(71) Applicant: DNS Designs, LLC, Pittsford, NY (US)

(72) Inventors: Scott Lawrence Peters, Pittsford, NY (US); David Whitney Lyndaker, Byron, NY (US)

(73) Assignee: DNS Designs, LLC, Pittsford, NY (US)

(21) Appl. No.: 18/123,676

(22) Filed: Mar. 20, 2023

Related U.S. Application Data
(60) Provisional application No. 63/322,804, filed on Mar. 23, 2022.

(51) Int. Cl. F16B 21/02

(52) U.S. Cl. CPC F16B 21/02

(57) ABSTRACT

A self engaging and disengaging coupler is disclosed with a male coupler half and a female coupler half that uses magnetic elements in combination with structural guide and retention elements on each coupler half to engage and releasably lock the self engaging and disengaging coupler. These structural elements in combination with the magnetic elements also allow the self engaging and disengaging coupler to release through one or more quick tugs on the strap, rope or connecting element that is attached to the self engaging and disengaging coupler. This ability to engage and release the self engaging and disengaging coupler allows for easy one-handed operation.

### CROSS REFERENCE TO RELATED PATENT APPLICATIONS

This application claims priority to U.S. Patent Application Ser. No. 63/322,804 filed Mar. 23, 2022 entitled “Self Engaging and Disengaging Coupler” by Scott Lawrence Peters et al., the entire disclosure of which is incorporated herein by reference.

### BACKGROUND OF THE INVENTION

### 1. Field of the Invention

The present invention relates generally to fastening devices, and more particularly to a self engaging and disengaging coupler.

### 2. Description of Related Art

A variety of fastening devices exist today that join two elements together. Those elements may include ropes, cables, straps, other flexible or semi-flexible elements, or even rigid elements. Those existing fastening devices often require engagement and subsequent disengagement with two hands. While this works well for some applications, there exists a need to engage and disengage a fastening device easily, with one hand, without the necessity for two handed operation and associated physical dexterity. For example, hanging or removing a heavy or bulky and cumbersome object from the ceiling often necessitates the need for assistance due to the two handed nature of the operation.

What is therefore needed is a fastening device that allows one to engage and disengage the fastening device without the need for two hands where the fastening device engages and disengages through the simple act of bringing two fastening elements together.

The present invention, and the various embodiments described and envisioned herein, meet this heretofore unmet need.

### BRIEF SUMMARY OF THE INVENTION

In accordance with the present invention, there is provided a self engaging and disengaging coupler comprising a male coupler half having a male magnetic element, a male engagement structure and a male coupling/decoupling structure; a female coupler half having a female magnetic element, a fixed barrel, a rotating barrel disposed within the fixed barrel, a female coupling structure disposed within the rotating barrel, and a female coupling/decoupling alignment structure disposed within the rotating barrel; the female coupler half configured to receive the male coupler half when the female coupler half and the male coupler half are drawn together through the attractive force of the male magnetic element and the female magnetic element.

The foregoing paragraph has been provided by way of introduction, and is not intended to limit the scope of the invention as described by this specification, claims and the attached drawings.

### BRIEF DESCRIPTION OF THE DRAWINGS

The invention will be described by reference to the following drawings, in which like numerals refer to like elements, and in which:

FIG. 1 is a perspective view of the self engaging and disengaging coupler prior to joining;

FIG. 2 is a perspective view of the self engaging and disengaging coupler once joined;

FIG. 3 is aside plan view of the self engaging and disengaging coupler prior to joining;

FIG. 4 is an alternate side plan view of the self engaging and disengaging coupler prior to joining;

FIG. 5 is an end plan view of the self engaging and disengaging coupler prior to joining;

FIG. 6 is an alternate end plan view of the self engaging and disengaging coupler prior to joining;

FIG. 7 is a side plan view of the self engaging and disengaging coupler once joined;

FIG. 8 is an alternate side plan view of the self engaging and disengaging coupler once joined;

FIG. 9 is a perspective view of the male coupler half of the self engaging and disengaging coupler;

FIG. 10 is a perspective view of the female coupler half of the self engaging and disengaging coupler;

FIG. 11 is an end plan view of the male coupler half of the self engaging and disengaging coupler;

FIG. 12 is an alternate perspective view of the female coupler half of the self engaging and disengaging coupler;

FIG. 13 is an end plan view of the female coupler half of the self engaging and disengaging coupler;

FIG. 14 is a further perspective view of the female coupler half of the self engaging and disengaging coupler;

FIG. 15 is an exploded view of the female coupler half of FIG. 14;

FIG. 16 is a further perspective view of the male coupler half of the self engaging and disengaging coupler;

FIG. 17 is an exploded view of the male coupler half of FIG. 16;

FIG. 18 is a perspective view of a male safety coupler half of the present invention in a retracted position;

FIG. 19 is a perspective view of a male safety coupler half of the present invention in an extended position;

FIG. 20 is an exploded view of the male safety coupler half of FIGS. 18 and 19;

FIG. 21 is a perspective view of a self engaging and disengaging coupler with a retention book attachment;

FIG. 22 is an exploded view of the self engaging and disengaging coupler of FIG. 21;

FIG. 23 is a perspective view of a self engaging and disengaging coupler with a retention strap attachment;

FIG. 24 is an exploded view of the self engaging and disengaging coupler of FIG. 23;

FIG. 25 is a perspective view of a self engaging and disengaging coupler with a retention lag bolt attachment;

FIG. 26 is an exploded view of the self engaging and disengaging coupler of FIG. 25;

FIG. 27 is a perspective view of a self engaging and disengaging coupler with a retention strap attachment; and

FIG. 28 is an exploded view of the self engaging and disengaging coupler of FIG. 27.

The present invention will be described in connection with a preferred embodiment, however, it will be understood that there is no intent to limit the invention to the embodiment described. On the contrary, the intent is to cover all alternatives, modifications, and equivalents as may be included within the spirit and scope of the invention as defined by this specification, claims and the attached drawings.

### DESCRIPTION OF THE PREFERRED EMBODIMENTS

For a general understanding of the present invention, reference is made to the drawings. In the drawings, like reference numerals have been used throughout to designate identical elements.

The present invention will be described by way of example, and not limitation. Modifications, improvements and additions to the invention described herein may be determined after reading this specification and viewing the accompanying drawings; such modifications, improvements, and additions being considered included in the spirit and broad scope of the present invention and its various embodiments described or envisioned herein.

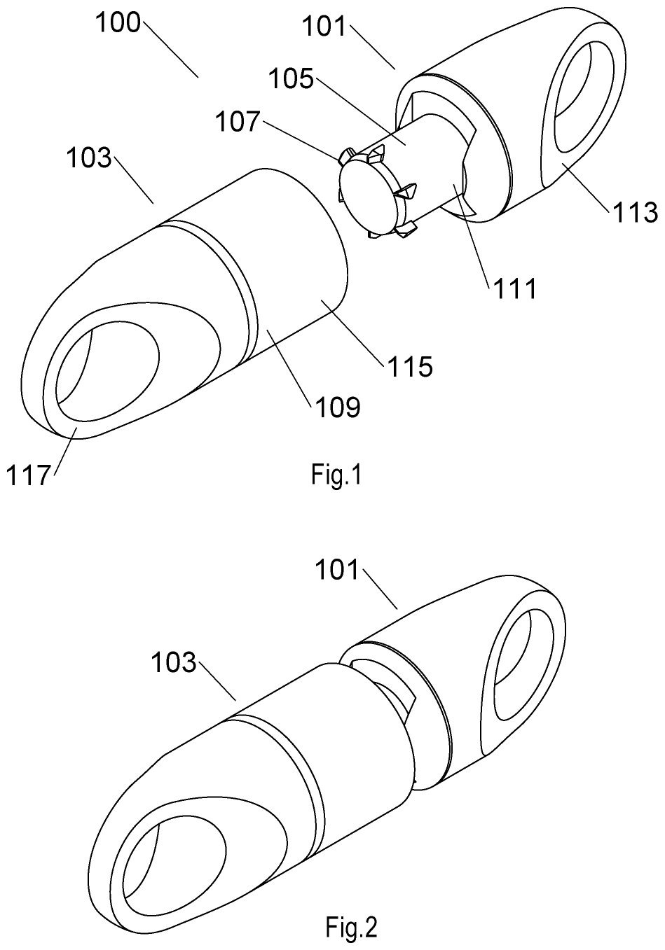

Referring to the present invention in detail, in FIG. 1 there is shown a perspective view of the self engaging and disengaging coupler prior to joining. The fundamental components depicted herein may, in many instances, be supplemented by additional components such as retainers, clips, loops, rings, karabiners, ropes, straps, wires, or the like, as subsequently depicted herein by example, and not limitation.

The self engaging and disengaging coupler of the present invention employs magnetic elements to draw the male coupler half 101 and the female coupler half 103 together and lock, and also to release, the coupler through a quick tug or series of tugs on the self engaging and disengaging coupler. This novel lock and release mechanism uses the attractive force of magnets of opposite polarity with structural guide and retention elements within the coupler.

Each coupler half contains one or more magnetic elements. The two magnetic elements may be ferrite magnets, alnico magnets, rare earth magnets (Neodymium. Samarium-cobalt, for example), or the like. In some embodiments of the present invention, one of the magnets may be replaced with a ferromagnetic material. In some embodiments of the present invention, the magnet may contain a ferromagnetic layer, plate, or component. Further, in some embodiments of the present invention, the magnets may be electromagnets that utilize a power source such as an energy harvester, a battery, an ultracapacitor, or the like.

In use, and as will be further described herein, opposite poles of each magnetic element face each other to provide an attractive force that serves to draw the male coupler half 101 and the female coupler half 103 together. In some embodiments of the present invention, the magnetic elements may have keying features machined or otherwise manufactured into the magnetic element and corresponding keying features in the male coupler half 101 and the female coupler half 103 to provide retention of the magnetic element and also ensure that the proper polarity is observed when the magnetic elements are installed into each coupler half. The magnetic elements may be installed into the coupler halves using adhesives or mechanical attachment techniques or a combination thereof. Mechanical attachment techniques include, but are not limited to, side undercuts, snap features, separate retention parts, keying features on the magnet and coupler half, or the like. The parts may be made from a plastic, a reinforced plastic, or a metal, and may be injection molded if they are a plastic, or may be cast, machined or stamped if they are a metal.

In FIG. 1, a perspective view of the self engaging and disengaging coupler prior to joining can be seen. The male coupler half 101 and the female coupler half 103 can be seen with the male magnetic element 11I facing the female magnetic element 109. The male and female magnetic elements are, in one embodiment, contained within their respective coupler half. This orientation of magnetic elements with opposite polarities facing each other provides a coupling force necessary for the self engaging and disengaging coupler to close together and lock. With the male coupler half 101, a male engagement structure 105 can be seen. In one embodiment of the present invention, the male engagement structure 105 is cylindrical. This male engagement structure 105 has a male coupling decoupling structure 107 that comprises fins or wedges around the periphery of the male engagement structure 105 as seen in FIG. 1. The fins or wedges may, in one embodiment of the present invention, be triangular, truncated triangular or a modified triangular like shape. The male engagement structure 105 is, for example, of a cylindrical shape with the male engagement coupling decoupling structure 107 circumferentially disposed thereupon. An attachment is then attached or otherwise formed with the male coupler half 101, such as the male attachment 113 seen in FIG. 1. Alternatively, the female coupler half 103 can be seen having a fixed barrel 115 for receiving the male engagement structure 105 of the male coupler half 101. At the base or similar location in the fixed barrel 115, a female magnetic element 109 is affixed. The female coupler half 103 also has an attachment such as the female attachment 117 depicted in FIG. 1 to allow for mechanical connection to other elements such as ropes, cables, strings, chains, couplings, or the like.

The female coupler half 103 also contains internal components that may be seen in subsequent figures. These internal components and their interaction with the male engagement structure 105 and the male coupling decoupling structure 107 allow for the engagement and release of the two coupler halves. Of course modifications to the geometries of the interacting components may be made to modify how the two coupler halves interact, engage, release, and the like. While six male coupling decoupling structures 107 can be seen, less than six or more than six male coupling decoupling structures 107 may be employed in some embodiments of the present invention.

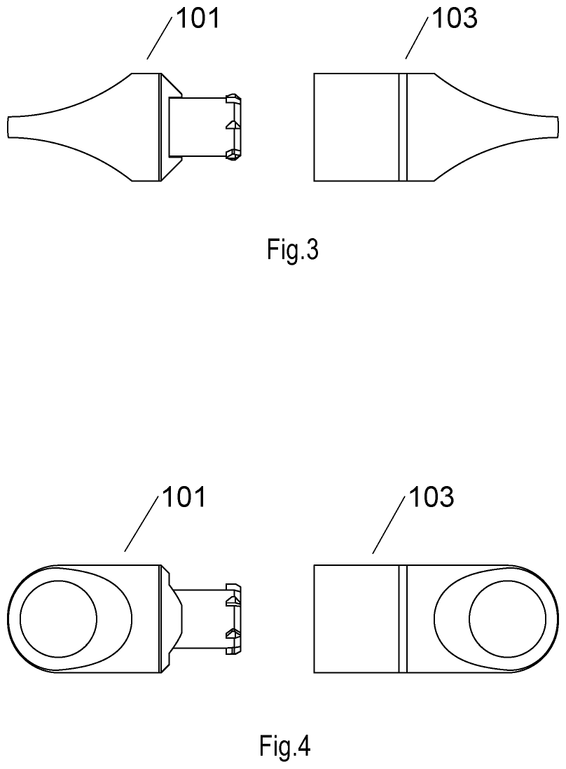

The self engaging and disengaging coupler 100 as depicted by way of example in FIGS. 1 and 2 may be used, for example, to connect and later disconnect two rope elements where the rope is pulled taut, then released, then pulled taut again.

A male attachment 113 and a female attachment 117 can be seen joined or formed with the male coupler half 101 and the female coupler half 103. While the attachments depicted in FIG. 1 are loops or eyelets, other attachments may also be employed. In addition, a swivel or rotational element may be included to counteract the natural rotational tendency of the self engaging and disengaging coupler. An example of a suitable attachment is a side release buckle for strapping. Variations on attachment types are to be considered part of the present invention and the various embodiments described and depicted herein.

Turning now to FIG. 2, a perspective view of the self engaging and disengaging coupler once joined is depicted. The male coupler half 101 and the female coupler half 103 can be seen engaged and locked. Unlocking is accomplished by simply releasing tension on the two coupler halves and then reapplying tension.

FIG. 3 is a side plan view of the self engaging and disengaging coupler prior to joining. The male coupling decoupling structure 107 can be clearly seen circumferentially disposed about the male engagement structure 105. In addition, the positioning of the male coupler half 101 with respect to the female coupler half 103 can be seen.

FIG. 4 is an alternate side plan view of the self engaging and disengaging coupler prior to joining, where the male coupler half 101 can be seen positioned with the female coupler half 103.

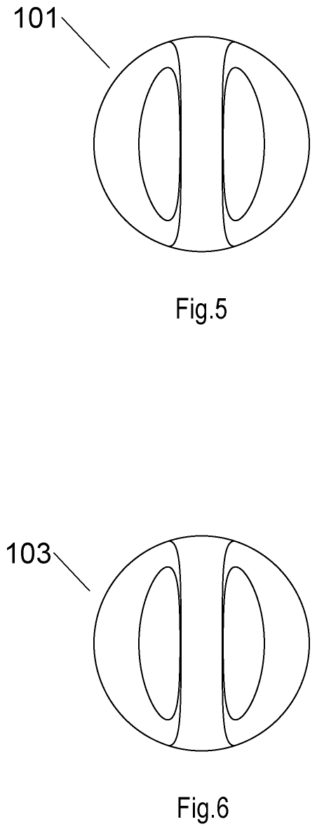

FIG. 5 is an end plan view of the self engaging and disengaging coupler prior to joining showing the end of the male coupler half 101. FIG. 6 is an alternate end plan view of the self engaging and disengaging coupler prior to joining showing the female coupler half 103. As previously stated, while the male attachment 113 and female attachment 117 are depicted as slots or openings, a wide variety of attachments may also be employed.

To use the self engaging and disengaging coupler, the male coupler half 101 and the female coupler half 103 are axially positioned as depicted in FIGS. 3 and 4, for example. As the two coupler halves are placed close together in this axial position, the magnetic force of each will serve to draw the two coupler halves together, with the male coupler half 101 joining with the female coupler half 103 until the two halves are completely joined. There is also an internal rotating barrel (see 1001, FIG. 10) that rotates to create proper alignment for locking. The locking of the two coupler halves occurs due to the magnetic interaction of both coupler halves in combination with the structural guide and retention features that are described herein. Once locked, the self-aligning coupler can withstand a load as long as the coupler is under tension. When the tension is released (for example, the rope or strap is temporarily allowed to go slack), and then the tension reapplied, the self-aligning coupler will release (de-couple).

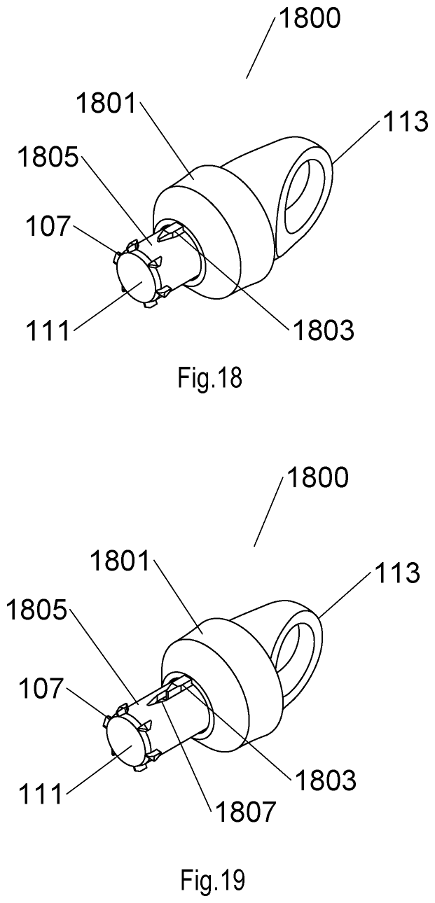

In some embodiments of the present invention, an additional locking or safety component is incorporated to ensure that the self engaging and disengaging coupler does not inadvertently release once joined. Such a safety component may comprise a pin, a latch, a retainer, a closure, a lock, or the like. FIGS. 18-20 depict an example of a safety mechanism.

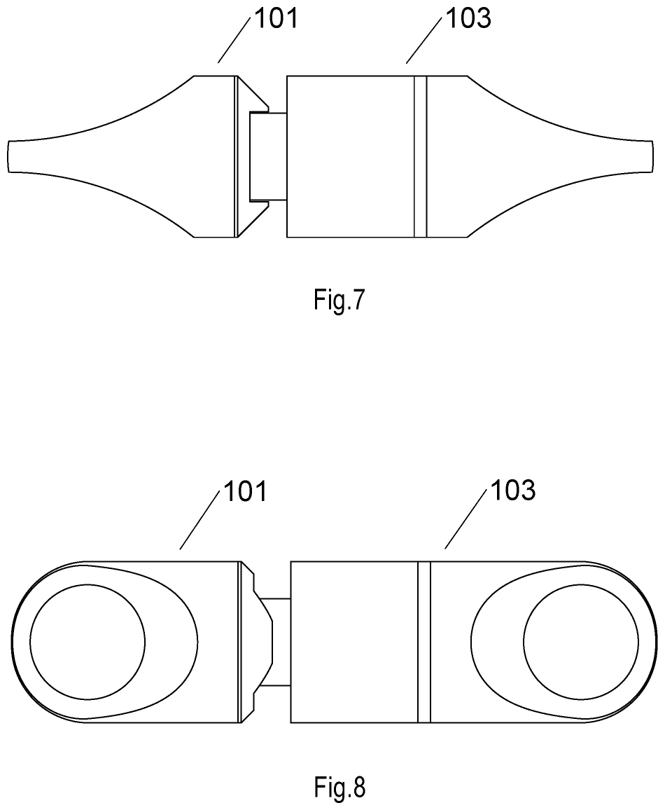

FIG. 7 is a side plan view of the self engaging and disengaging coupler once joined and FIG. 8 is an alternate side plan view of the self engaging and disengaging coupler once joined.

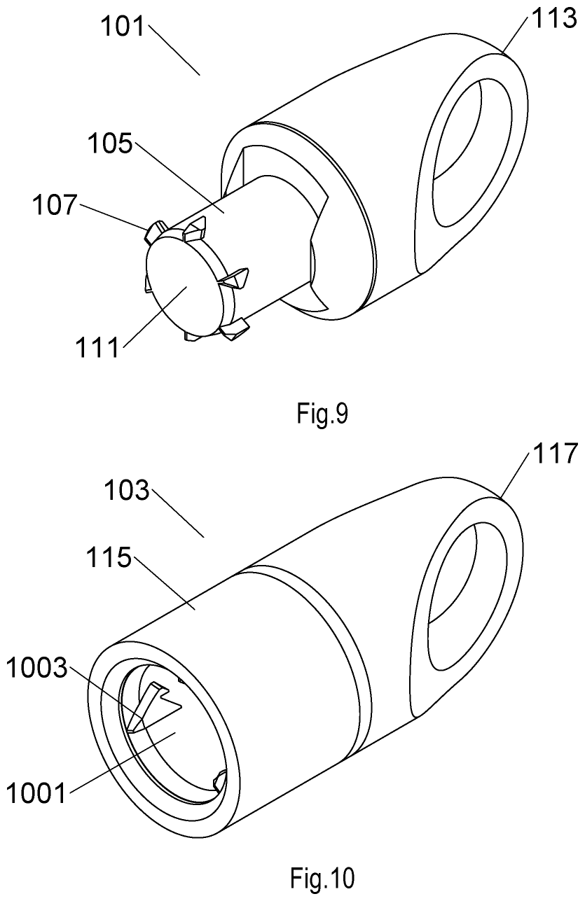

For a complete understanding of both coupler halves, FIG. 9 is a perspective view of the male coupler half 101 of the self engaging and disengaging coupler 100 showing the male magnetic element 111 as well as the male engagement structure 105 and the male coupling decoupling structure 107.

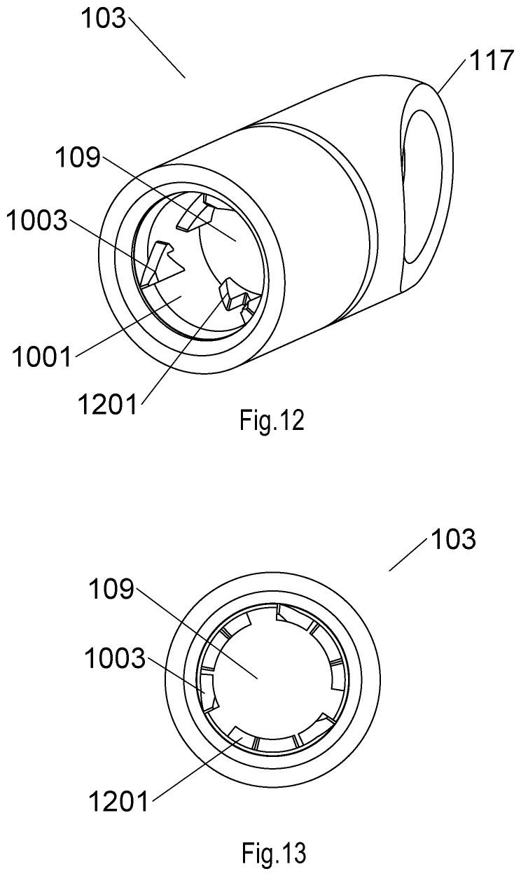

FIG. 10 is a perspective view of the female coupler half 103 of the self engaging and disengaging coupler 100 showing clearly the rotating barrel 1001 where the male couple half 101 is inserted. The rotating barrel 1001 is rotationally disposed within the fixed barrel 115. The rotational mechanism may simply be low friction interaction of the two parts, or may, in some embodiments, contain further moving parts such as bearings, slides, grooves, or the like. Importantly, the female coupling structure 1003 can be seen. The female coupling structure is a protruding geometry on the inside of the rotating barrel 1001. The geometry may be an angular structure such as, for example, a generally triangular structure with a notch or a groove as depicted in FIG. 10. There are three female coupling structures 1003 within the rotating barrel 1001. In some embodiments of the present invention, there may be more than three or less than three female coupling structures. The point of each male coupling decoupling structure 107 is retained by the notch or groove in each female coupling structure 1003. Interaction with additional features in the female coupler half 103 provide for aligned engagement and subsequent disengagement of the two coupler halves. Those features will be seen and described by way of FIG. 12.

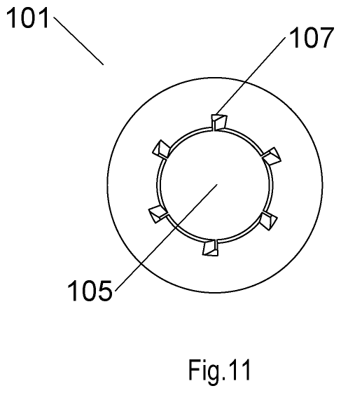

FIG. 11 is an end plan view of the male coupler half 101 of the self engaging and disengaging coupler 100 showing the male engagement structure 105 and the male coupling decoupling structure 107.

FIG. 12 is an alternate perspective view of the female coupler half 103 of the self engaging and disengaging coupler 100 where the female magnetic element 109 can be seen. The female magnetic element 109 is placed within, and at the base of, the rotating barrel 1001. The female coupling structure 1003 can be seen along with female coupling decoupling alignment structures 1201. The female coupling decoupling alignment structures 1201 are affixed or otherwise molded with the rotating barrel 1001 and can be seen circumferentially attached there within. When the male engagement structure 105 of the male coupler half 101 enters the rotating barrel 1001 of the female coupler half and proceeds toward the bottom of the female rotating barrel 1001, the male coupling decoupling structure 107 encounters the female coupling decoupling alignment structure 1201. The angles of the female coupling decoupling alignment structure 1201 serve to rotate the rotating barrel 1001 such that the male coupling decoupling structure 107 engages with the notch or groove of the female coupling structure 1003, or alternatively, if tension between the two coupler halves is released and then reapplied, the female coupling decoupling alignment structure 1201 moves the rotating barrel 1001 further such that the male coupling decoupling structure misses the notch or groove in the female coupling structure 1003, causing the two coupler halves to release.

FIG. 13 is an end plan view of the female coupler half 103 of the self engaging and disengaging coupler 100 showing the female magnetic element 109 with the female coupling structure 1003 circumferentially disposed around the rotating barrel 1001. The female coupling decoupling alignment structure 1201 can also be seen toward the bottom of the rotating barrel 1001.

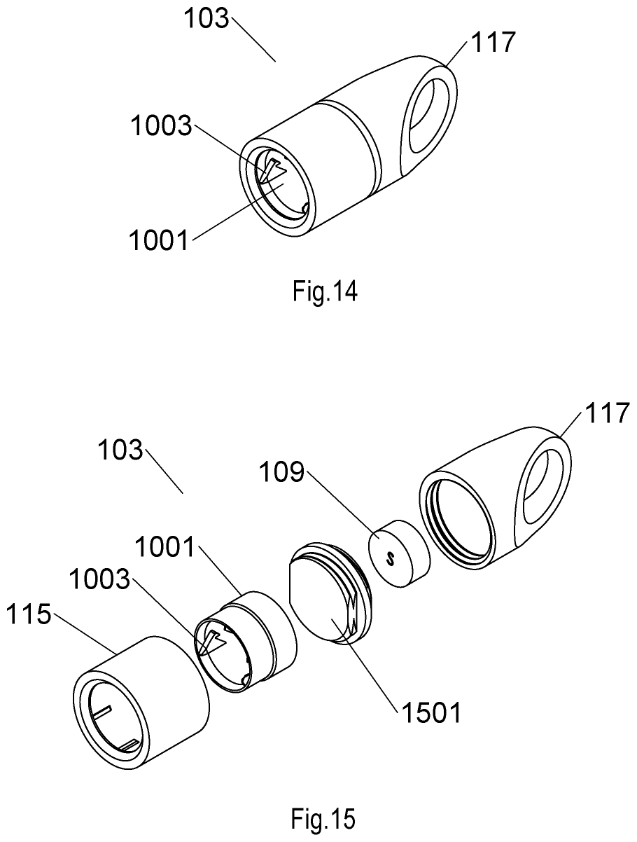

FIG. 14 is a further perspective view of the female coupler half 103 of the self engaging and disengaging coupler 100 for reference when viewing FIG. 15.

FIG. 15 is an exploded view of the female coupler half 103 of FIG. 14 showing the rotating barrel 1001 coaxially disposed within the fixed barrel 115. The female magnetic element 109 can be clearly seen retained by a female fastening element 1501 such as a threaded cap or the like. Also, the female attachment 117 can be seen removably attached to the female coupler half 103, allowing for the interchange of attachments, as later seen in FIGS. 22-28.

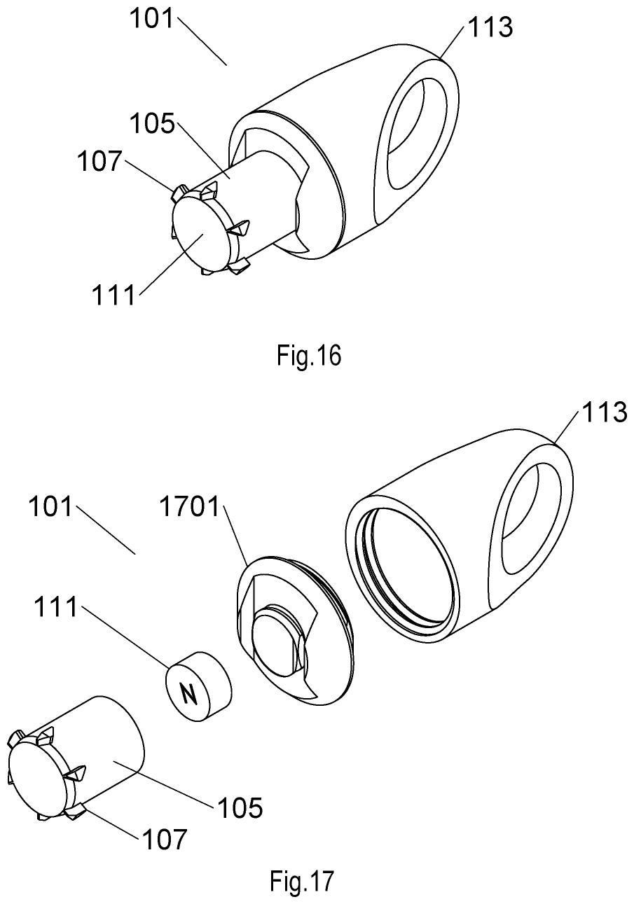

FIG. 16 is a further perspective view of the male coupler half 101 of the self engaging and disengaging coupler 100 for reference when viewing FIG. 17.

FIG. 17 is an exploded view of the male coupler half of FIG. 16 clearly showing the male magnetic element 111 retained by a male fastening element 1701 such as a threaded cap or the like. Also, the male attachment 113 can be seen removably attached to the male coupler half 101, allowing for the interchange of attachments, as later seen in FIGS. 22-28.

FIG. 18 is a perspective view of a male safety coupler half 1800 of the present invention in a retracted position. A male engagement structure 1805 can be seen with a slot 1807 (see FIG. 19) and a rib 1803 contained within the slot 1807. A safety barrel 1801 can be seen engaged with the rib 1803, preventing a slack condition from causing an unintended release of the coupler halves.

FIG. 19 is a perspective view of a male safety coupler half of the present invention in an extended position showing the rib 1803 extended in the slot 1807.

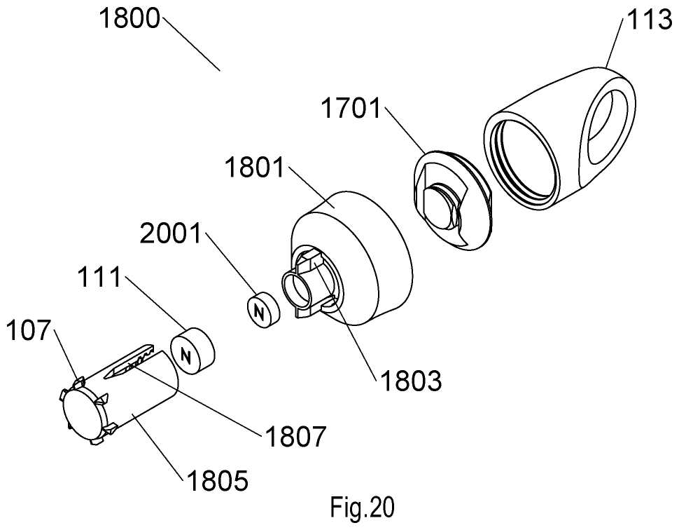

FIG. 20 is an exploded view of the male safety coupler half of FIGS. 18 and 19. A safety magnet 2001 can be seen contained within the male engagement structure 1805. The ribs 1803 (two in this example) can also be seen affixed to or molded with the safety barrel 1801.

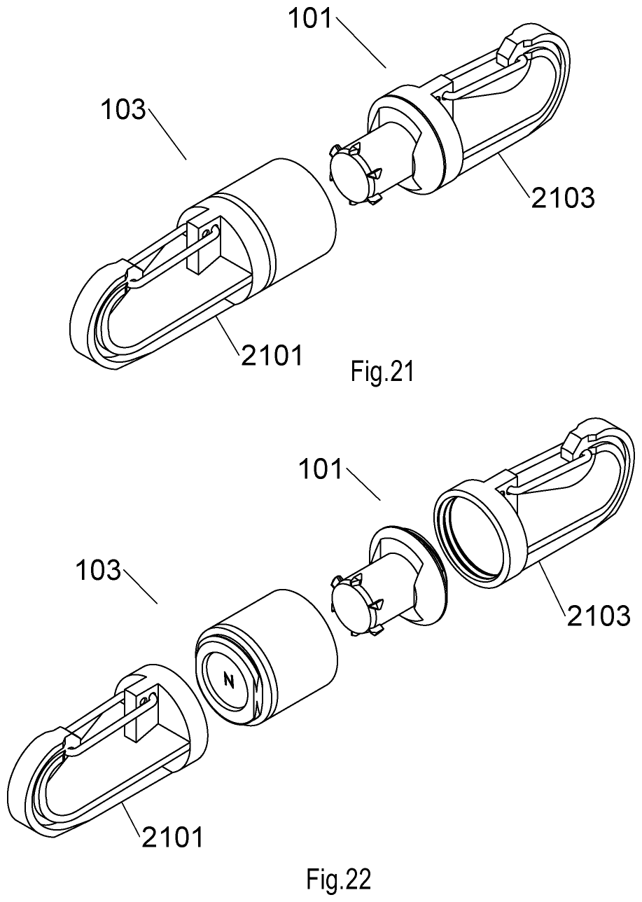

Various examples of attachment elements are depicted in FIGS. 21-28. The attachment elements can be interchangeable with the coupler halves, allowing for numerous and varied applications thereof.

FIG. 21 is a perspective view of a self engaging and disengaging coupler 2100 with a retention hook attachment 2101 and 2103. FIG. 22 is an exploded view of the self engaging and disengaging coupler of FIG. 21;

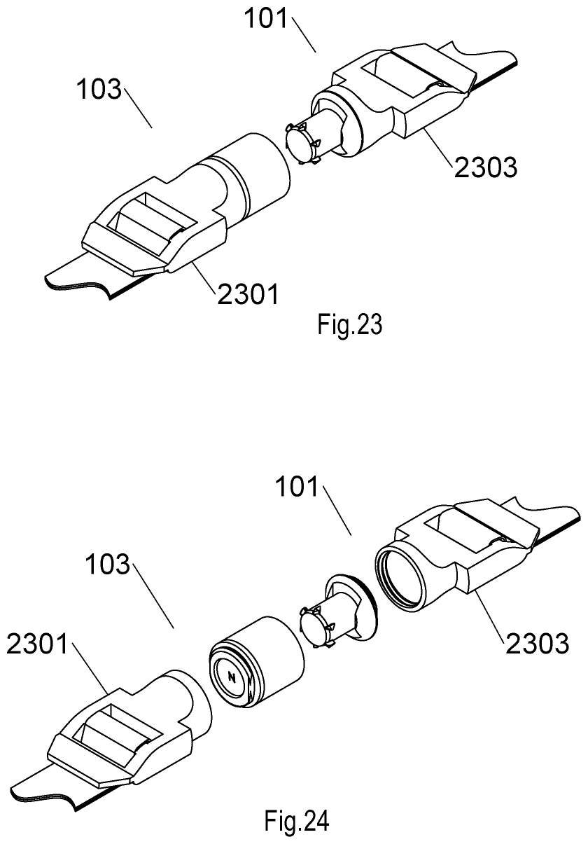

FIG. 23 is a perspective view of a self engaging and disengaging coupler 2300 with a retention strap attachment 2301 and 2303. FIG. 24 is an exploded view of the self engaging and disengaging coupler of FIG. 23. In some embodiments of the present invention, the retention strap element or attachment comprises a quick side release buckle, for example, a quick side release buckle suitable for strapping such as one inch nylon braided strapping.

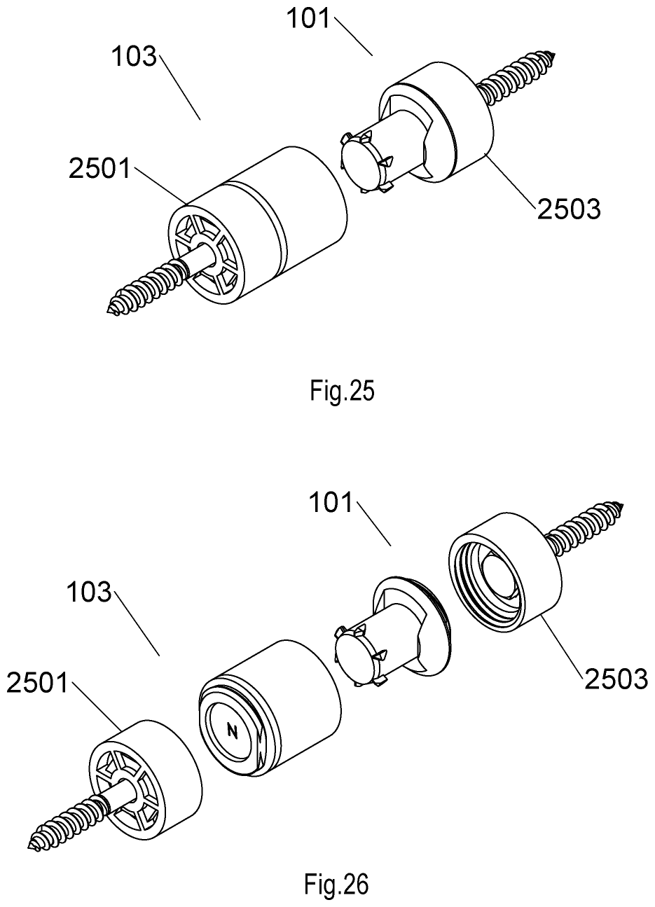

FIG. 25 is a perspective view of a self engaging and disengaging coupler 2500 with a retention lag bolt attachment 2501 and 2503. FIG. 26 is an exploded view of the self engaging and disengaging coupler of FIG. 25.

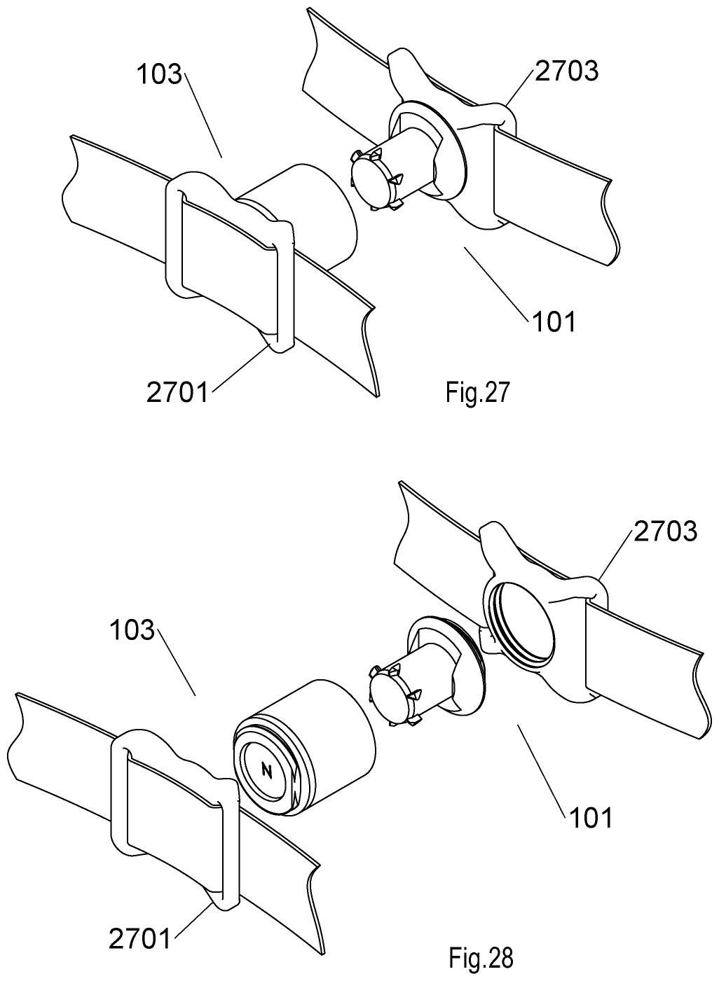

FIG. 27 is a perspective view of a self engaging and disengaging coupler 2700 with a retention strap attachment 2701 and 2703. FIG. 28 is an exploded view of the self engaging and disengaging coupler of FIG. 27.

It is, therefore, apparent that there has been provided, in accordance with the various objects of the present invention, a self engaging and disengaging coupler. While the various objects of this invention have been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of the present invention as defined by this specification, claims and the attached drawings.

What is claimed is:

1. A self engaging and disengaging coupler comprising:
a male coupler half having a male magnetic element, a male engagement structure and a male coupling/decoupling structure;
a female coupler half having a female magnetic element, a fixed barrel, a rotating barrel disposed within the fixed barrel, a female coupling structure disposed within the rotating barrel, and a female coupling/decoupling alignment structure disposed within the rotating to barrel;
the female coupler half configured to receive the male coupler half when the female coupler half and the male coupler half are drawn together through the attractive force of the male magnetic element and the female magnetic element.

2. The self engaging and disengaging coupler of claim 1, wherein the male coupler half further comprises a male attachment.

3. The self engaging and disengaging coupler of claim 1, wherein the male attachment is a retention hook element.

4. The self engaging and disengaging coupler of claim 1, wherein the male attachment is a retention safety hook element.

5. The self engaging and disengaging coupler of claim 1, wherein the male attachment is a retention strap element.

6. The self engaging and disengaging coupler of claim 1, wherein the male attachment is a retention lag bolt element.

7. The self engaging and disengaging coupler of claim 1, wherein the male attachment is a quick side release buckle.

8. The self engaging and disengaging coupler of claim 1, further comprising a male fastening element for retention of the male magnetic element.

9. The self engaging and disengaging coupler of claim 1, further comprising a female fastening element for retention of the female magnetic element.

10. A self engaging and disengaging coupler comprising:
a male safety coupler half having a male magnetic element, a male engagement structure having a slot, a male coupling/decoupling structure, a safety barrel engaged with a rib, and the rib disposed within the slot of the male engagement structure;
a female coupler half having a female magnetic element, a fixed barrel, a rotating barrel disposed within the fixed barrel, a female coupling structure disposed within the rotating barrel, and a female coupling/decoupling alignment structure disposed within the rotating barrel;
the female coupler half configured to receive the male coupler half when the female coupler half and the male coupler half are drawn together through the attractive force of the male magnetic element and the female magnetic element.

11. The self engaging and disengaging coupler of claim 10, wherein the male coupler half further comprises a male attachment.

12. The self engaging and disengaging coupler of claim 10, wherein the male attachment is a retention hook element.

13. The self engaging and disengaging coupler of claim 10, wherein the male attachment is a retention safety hook element.

14. The self engaging and disengaging coupler of claim 10, wherein the male attachment is a retention strap element.

15. The self engaging and disengaging coupler of claim 10, wherein the male attachment is a retention lag bolt element.

16. The self engaging and disengaging coupler of claim 10, wherein the male attachment is a quick side release buckle.

17. The self engaging and disengaging coupler of claim 10, further comprising a male fastening element for retention of the male magnetic element.

18. The self engaging and disengaging coupler of claim 10, further comprising a female fastening element for retention of the female magnetic element.

19. A self engaging and disengaging coupler comprising:
a male coupler half having a male magnetic element, a cylindrically formed male engagement structure and at least one male coupling/decoupling structure circumferentially disposed on the cylindrically formed male engagement structure;
a female coupler half having a female magnetic element, a fixed barrel, a rotating barrel disposed within the fixed barrel, a female coupling structure disposed within the rotating barrel, and a female coupling/decoupling alignment structure disposed within the rotating barrel;
the female coupler half configured to receive the male coupler half when the female coupler half and the male coupler half are drawn together through the attractive force of the male magnetic element and the female magnetic element.

20. The self engaging and disengaging coupler of claim 19, further comprising a slot within the male engagement structure and a safety barrel engaged with a rib, wherein the rib is disposed within the slot of the male engagement structure.
